(19) United States
(12) Patent Application Publication
(10) Pub. No.: US 2005/0131770 A1
(43) Pub. Date: Jun. 16, 2005

(54) Method and system for aiding product configuration, positioning and/or pricing

(76) Inventor: Aseem Agrawal, Arlington, VA (US)

Correspondence Address: Frederick W. Gibb, III;McGinn & Gibb, PLLC, Suite 304, 2568-A Riva Road, Annapolis, MD, 21401, US

(21) Appl. No.: 10/735,558

(22) Filed: Dec. 12, 2003

(51) Int. Cl. G06F 17/60

(52) U.S. Cl. 705/26

(57) ABSTRACT

Methods, systems and computer program products for aiding new product introduction and for identifying a need for reconfiguring, repositioning and/or repricing existing products are disclosed herein. For the case of new products, data relating to a proposed new product is obtained from a merchant, data relating to products similar to the proposed new product is obtained from competitors' websites and processed, product attributes and positioning attributes are identified based on the processed data, and at least one marketing mix for the proposed new product is identified based on the identified attributes. Alternatively, online market research is conducted based on the identified attributes and the at least one proposed new product is identified based on a result of the online market research. For the case of existing products, data relating to one or more of a merchant's products is obtained and data relating to products similar to the merchant's products is periodically obtained from competitors' websites. The data relating to similar products is processed and product and positioning attributes are identified based on the processed data. One or more of the merchant's products that require repositioning and/or repricing are identified based on a change detected in the identified product and positioning attributes.

### FIELD OF THE INVENTION

The present invention relates to configuration, positioning and/or pricing of new products and reconfiguration, repositioning and/or repricing of existing products.

### BACKGROUND

In an increasingly competitive world, businesses or merchants wishing to enter a market segment or maintain a position in a market segment constantly need to introduce new products and reposition existing products. Existing products that might have historically helped gain market share frequently face declining revenues as a result of increased competition, new technologies, and changes in customer preferences.

Merchants or businesses seeking to introduce new products typically generate product configurations manually and then test the configurations out using market research. The market research is frequently outsourced to agencies, which determine a product's positioning based on heuristic judgment and/or inputs from advertising professionals.

The various stages of a new product development process include generating and screening ideas, developing and testing alternate product concepts, developing a marketing strategy (including segmenting the market and determining the target market segment, positioning the product, determining product pricing, distribution, etc.), testing the marketing mix, conducting a technical feasibility and costing study, going into limited production, and finally, going into full production.

One technique used in the idea generation phase is that of Attribute Listing, in which the values of major attributes of a product are listed and subsequently modified in search of a better product. A large number of combinations may be generated, which may be subsequently pared down, frequently based on heuristic judgment. Such judgment typically factors in competitive offerings. Market research may then be conducted to elicit customer opinion and techniques such as conjoint analysis and multi-dimensional scaling may be used for drawing conclusions. A large number of responses from each respondent are necessary for the results to be meaningful. Additional information relating to the techniques referred to above may be found in a book by Green, P., Tull, D., and Albaum, G., entitled “Research for Marketing Decisions”, 5^{th} Edition, Prentice Hall, 1988.

Product pricing and positioning are typically based on a multiplicity of factors, including pricing and positioning of competitors' products. However, tracking of the offerings of a large number of competitors is difficult and requires substantial resources. Moreover, even when the positioning of competitive products is known, subjective judgment is usually relied upon to determine product positioning.

A further potential problem for merchants or businesses is that existing product pricing and/or positioning might cease to be appropriate as the market evolves, thus resulting in declining revenues. Businesses and merchants are generally unable to detect such a situation, particularly at an early stage, unless costly market research is continually conducted in relation to each potentially competitive product.

U.S. Patent Application No. 20020055832 A1, entitled “Structured System for the Planning, Integration, Analysis and Management of New Product Development on a Real-time, Enterprise-wide Basis”, was filed in the names of Donelan A. T., Brown R. G., and Moore R. S. on Jun. 22, 2001 and published on May. 9, 2002. The specification relates to a structured system for managing production tasks involved in the development of a new product.

International Publication No. WO 02/03225 A2, entitled “Method and System for Product Lifecycle Management” was filed on Jun. 15, 2001 in the names of Davies J., Chabot P., and Rubin M and published on Jan. 10, 2002. The specification relates to a network-enabled software engine that assists users to coordinate and keep track of the progress and status of activities relating to new product development and product lifecycle management in an enterprise.

U.S. Patent Application No. 20010010041A1, entitled “Method for New Product Development and Market Introduction”, was filed in the name of Harshaw B. F. on Dec. 19, 2000 and published on Jul. 26, 2001. The specification relates to a method for management of a pool of new product concepts and ideas by a third party manager, including development and licensing of a new product selected from the pool.

Japanese Patent Application No. JP2001243340 A2, entitled “Product Definition in Customer Service Processing System”, was filed in the name of International Business Machines (IBM) Corporation on Feb. 28, 2000 and published on Sep. 7, 2001. The specification addresses the problem of reducing costs by reducing the time taken to introduce new products or modify existing products. None of the above references appear to aid pricing and/or positioning of new or existing products.

A need exists for a method, a system, and a computer program product to assist businesses and merchants in relation to configuration, positioning and/or pricing of new and existing products.

### SUMMARY

Aspects of the present invention provide automated methods for aiding new product introduction and for identifying a need for reconfiguring, repositioning and/or repricing existing products.

For the case of new product introduction, data relating to a proposed new product is obtained from a merchant, data relating to products similar to the proposed new product is obtained from competitors' websites and processed, product attributes and positioning attributes are identified based on the processed data, and at least one marketing mix for the proposed new product is identified based on the identified attributes. Alternatively, online market research is conducted based on the identified attributes and the at least one proposed new product is identified based on a result of the online market research.

For the case of existing products, data relating to one or more of a merchant's products is obtained, data relating to products similar to the merchant's products is periodically obtained from competitors' websites and processed, product attributes and positioning attributes are identified based on the processed data, a change in the identified product and positioning attributes relating to the at least one similar product is identified, and one or more of the merchant's products that require repositioning and/or repricing are identified based on the detected change.

Other aspects of the present invention provide systems and computer program products for practising the methods disclosed herein.

### BRIEF DESCRIPTION OF THE DRAWINGS

Embodiments are described hereinafter, by way of example only, with reference to the accompanying drawings in which:

FIG. 1 is a flow diagram of a method for aiding new product introduction;

FIG. 2 is a more detailed flow diagram of a method for aiding new product introduction;

FIG. 3 is a flow diagram of a method for identifying a need for reconfiguring, repositioning and/or repricing a product;

FIG. 4 is a more detailed flow diagram for identifying a need for reconfiguring, repositioning and/or repricing a product and aiding a merchant to reconfigure, reposition and/or reprice the product;

FIG. 5 is a schematic block diagram of a system for practicing embodiments of the present invention; and

FIG. 6 is a schematic representation of a computer system suitable for practicing embodiments of the present invention.

### DETAILED DESCRIPTION

Embodiments of methods, systems and computer program products are described hereinafter for aiding product configuration, positioning and/or pricing. More specifically, embodiments described hereinafter aid new product introduction and reconfiguration, repricing and/or repositioning of existing products.

The term “product”, as used in the present specification, is intended to comprise both products and services offered by a merchant or business. A product possesses one or more attributes (‘product attributes’). For example, attributes of a mobile phone comprise size, weight, battery life, technology standards supported (e.g., GSM), number of ring-tones, presence or absence of built-in camera, etc.

The terms “configuration” and “reconfiguration”, as used in the present specification, are intended to refer to the identification or determination of product attribute values.

Merchants and businesses strive to “position” their products, which essentially entails creating a real or perceived difference in a customer's mind between the merchant or business's products and competing products. Either product attributes or key benefits are focussed on to achieve this. These dimensions which a company may use to position their products may be called positioning attributes. Examples of positioning attributes comprise:
Weight: e.g., “the lightest cellphone”.
Price: e.g., “Dress for less (Ross Stores)”
Flavor: e.g., Lightly flavored v/s highly flavored yoghurt, with each positioning targeted to different groups
Looks: e.g. Sporty-looking v/s conservative-looking sports car, with each positioning targeted to different groups.

Competitors comprise parties that offer similar products. Similar products not only comprise products of obvious similarity (e.g., two mobile phones from Nokia and Ericsson), but may also comprise products that offer a similar service (e.g., a video cassette player and a DVD player).

Embodiments disclosed hereinafter may require the formulation and performance of explicit and/or implicit Online Market Research (OMR) experiments to assist in gathering data by asking for or observing respondents' preferences. Techniques for conducting OMR are disclosed in co-pending U.S. patent application Ser. No. 10/321017, entitled “Method and System for Conducting Online Marketing Research in a Controlled Manner”, which is incorporated herein by reference.

Certain embodiments disclosed hereinafter are automated in that steps of methods, sub-systems, and program code are performed or operate without human intervention apart from input by the merchant.

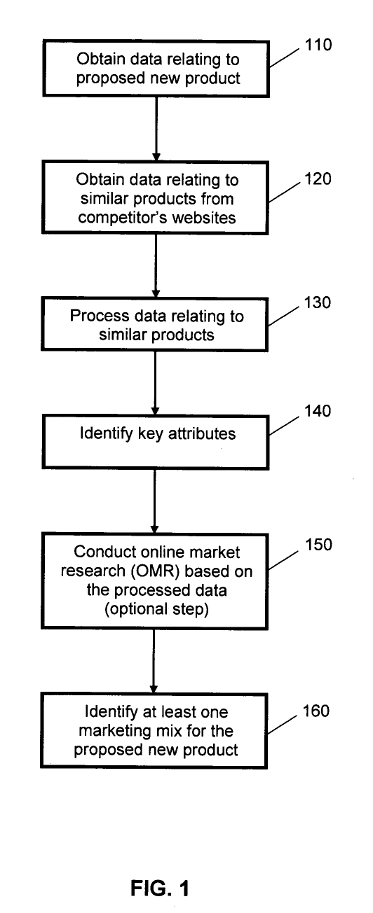

FIG. 1 shows an automated method for aiding new product introduction. Data relating to a proposed new product is obtained at step 110. At step 120, data relating to products similar to the proposed new product is obtained from competitors' websites. The data relating to the similar products is processed at step 130 and key attributes are identified based on the processed data at step 140. Online market research based on the key attributes is optionally conducted at step 150 and at least one marketing mix for the proposed new product is identified at step 160. The at least one marketing mix may be identified based on the key attributes identified in step 140 or the results of the online market research conducted at step 150, if online market research is conducted, and is representative of customer or market preferences or the ideal market position. A marketing mix may comprise one or more of a product configuration, a product price and a product position.

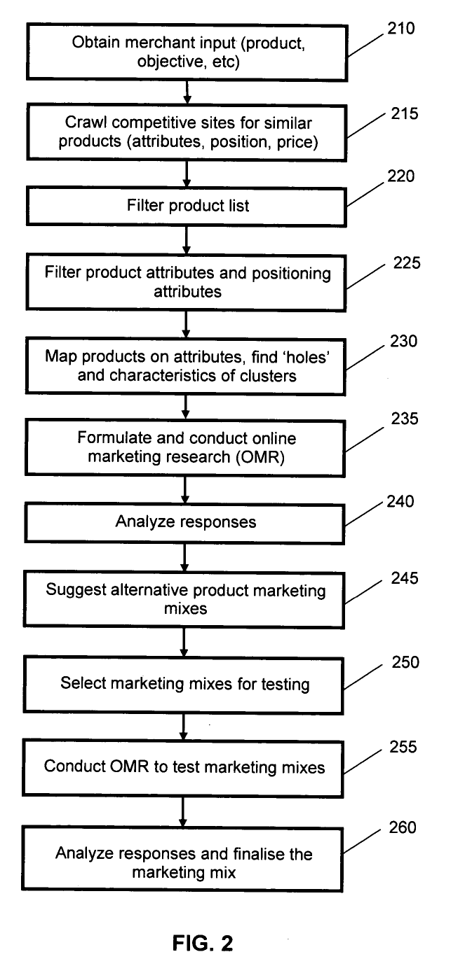

FIG. 2 shows a more detailed flow diagram of a method for aiding new product introduction. At step 210, merchant input relating to the product is obtained. Attributes of the product, along with attribute value ranges of interest to the merchant may also be specified. The merchant may further specify an objective such as maximization of revenue, profit, unit sales, etc.

At step 215, competitors' websites are crawled to identify products similar to the specified product. For each match found, a variety of data is gathered, including product attribute name-value pairs, pricing (including list price, discounts, credit terms, etc.), and positioning attribute name-value pairs. The products identified based on merchant-specified criteria and/or other criteria based on domain knowledge preconfigured into the subsystem are filtered to produce a shortlist of products at step 220. Attribute value ranges specified in step 210 may be used as filtering criteria. Other criteria used for filtering may comprise criteria such as the main geographical areas the merchant operates in, the top 10 products by revenue, etc. The merchant may optionally be shown the entire list or a filtered list of products for shortlisting or ratification.

At step 225, the product and positioning attributes are filtered to produce a shortlist of attributes based on one or more of the following: merchant-specified criteria, frequency of occurrence of the actual attributes in the list, other predefined criteria, or on explicit selection by the merchant.

The shortlisted products are mapped onto the shortlisted attributes, with separate maps being created for product attributes and positioning attributes, at step 230. ‘Holes’, which are points on the product attribute map where there are no existing products, are identified. Such may be due to unattractive attribute combinations or potential opportunities overlooked by competitors. The maps and any holes identified may be disclosed to the merchant either graphically or otherwise to enable the merchant to ratify or modify the holes, and also to classify the holes as unattractive or attractive. Clusters of products with similar attributes may be formed using clustering techniques. The attributes for clustering may be drawn from both the product and positioning attributes and the distance ‘metric’ used in clustering may factor in merchant-specified objectives (e.g., revenue, market share, etc.) in a case where the merchant wishes to guide the clustering process. Common product and positioning attributes of successful and unsuccessful products may be drawn from the clusters. These attributes represent successful and unsuccessful combinations that the merchant may wish to replicate or avoid, respectively, when the new product is introduced.

Conjoint and other data analysis techniques may be applied to the cluster data to analyze which attribute values contribute to a product's success. However, as the data available is frequently inadequate, one or more explicit and/or implicit Online Market Research (OMR) experiments are formulated and conducted, at step 235, to assist in gathering the missing data by asking for or observing respondents' preferences. OMR experiments are also formulated to analyze respondents' perceptions of the shortlisted product offerings of competitors based on the shortlisted positioning attributes. Optionally, the formulated experiments are disclosed to the merchant for validation or modification, either explicitly or implicitly by specification of a budget, number of respondents, etc. The additional experiments are offered to respondents visiting the merchant' website or other collaborating websites, and responses thereto are collected.

The data gathered in the OMR is analyzed, at step 240, along with the shortlisted set of attributes to create a perceptual map and find ideal product configurations using conjoint analysis, an unfolding model, other multi-dimensional scaling techniques, or any other appropriate techniques. The OMR data may further be used to classify the unclassified ‘holes’ as attractive or unattractive and to combine with attributes of clusters of successful and unsuccessful products.

Alternative marketing mixes, typically comprising product configurations, positioning and/or pricing, are suggested to the merchant, at step 245. Characteristics of the mixes may be derived from the product-positioning attribute map and the perceptual map. At step 250, one or more marketing mixes are selected for further testing. Such may be selected by the merchant.

Further OMR experiments are formulated and conducted at step 255 to test the marketing mixes selected in step 250.

The responses to the OMR experiments conducted in step 255 are analyzed at step 260. The alternative marketing mixes may be ranked in terms of their acceptance by customers or respondents to the OMR and displayed to the merchant for final selection. If the performance of all the marketing mixes in the OMR is unacceptable to the merchant, new marketing mixes may be suggested and tested with subsequent OMR experiments. Such suggestions may be obtained from the merchant. The cycle of selecting and testing marketing mixes may continue until an acceptable mix is obtained or the process is aborted by the merchant.

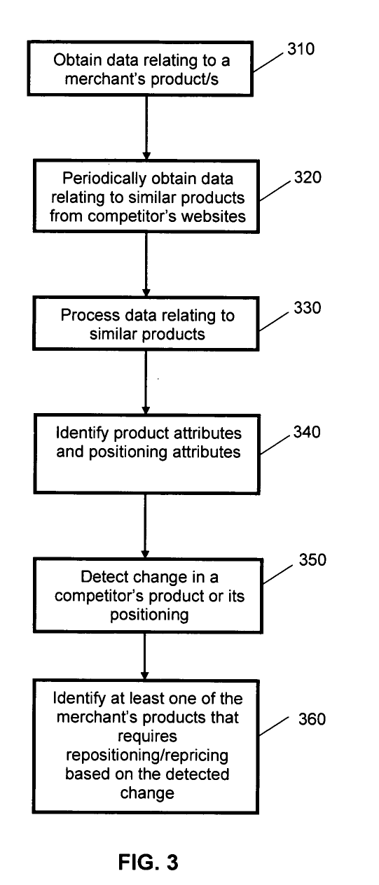

FIG. 3 shows a method for identifying a need for reconfiguring, repositioning and/or repricing a product. Data relating to one or more of a merchant's products is obtained at step 310. Data relating to products similar to the merchant's product is periodically obtained from competitor's websites, at step 320. The data relating to the similar products is processed at step 330. Such processing may comprise filtering, mapping and clustering of product and position attributes, as described in other embodiments herein. At step 340, product and positioning attributes are identified. Market positions of competitors' products, including pricing, are thus periodically monitored. At step 350, any change in positioning, attributes or pricing of a competitor's product is detected. At step 360, at least one new potential market position for the merchant's product that requires repositioning and/or repricing is identified based on the change detected in step 350.

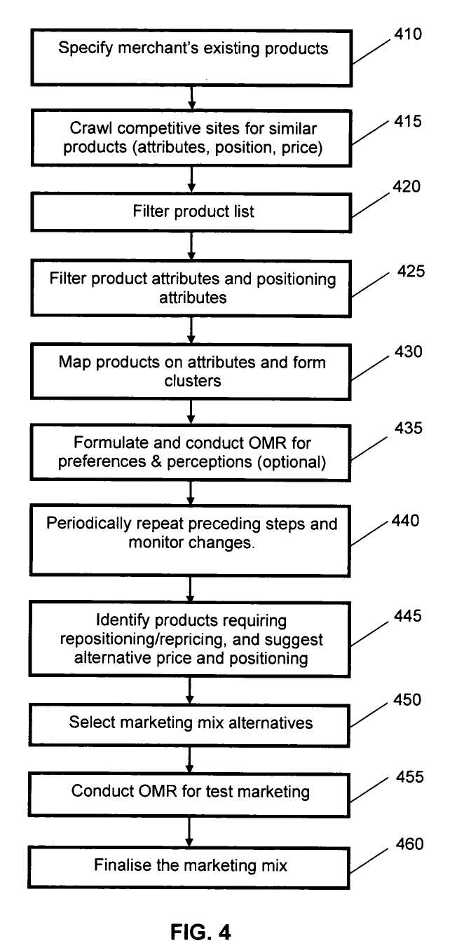

FIG. 4 shows a more detailed flow diagram of a method for aiding product reconfiguration, repositioning and/or repricing. This embodiment alerts a merchant about the need for changing positioning and/or pricing of a product and assists with achieving the repositioning and/or repricing.

At step 410, the merchant's existing products, along with positioning, pricing, and current sales data, etc., relating to those products, are specified. These may be read from another system where they are stored or from the inputs entered during previous iterations of the repositioning exercise or when the product was originally positioned. Alternatively, a subset of the merchant's products may be specified.

At step 415, competitors' websites are crawled to identify products similar to the specified products. For each match found, a variety of data is gathered, including product attribute name-value pairs, pricing (including list price, discounts, credit terms, etc.), and positioning attribute name-value pairs. The products identified based on merchant-specified criteria and/or other criteria based on domain knowledge preconfigured into the subsystem are filtered to produce a shortlist of products at step 420. Attribute value ranges specified in step 410 may be used as filtering criteria. Other criteria used for filtering may comprise criteria such as the main geographical areas the merchant operates in, the top 10 products by revenue, etc. The merchant may optionally be shown the entire list or a filtered list of products for shortlisting or ratification.

At step 425, the list of product and positioning attributes is filtered to produce a shortlist of attributes based on one or more of the following: merchant-specified criteria, frequency of occurrence of the actual attributes in the list, other predefined criteria, and explicit selection by the merchant.

The shortlisted products are mapped onto the shortlisted attributes, with separate maps being created for product attributes and positioning attributes, at step 430. Holes, which are points on the attribute maps where there are no existing products, are identified. Such may be due to unattractive attribute combinations or potential opportunities overlooked by competitors. The maps and any holes identified may be disclosed to the merchant either graphically or otherwise to enable the merchant to ratify or modify the holes, and also to classify the holes as unattractive or attractive. Clusters of products with similar attributes may be formed using clustering techniques. The attributes for clustering may be drawn from both the product and positioning attributes and may comprise certain merchant-specified attributes (e.g., revenue, market share, etc.) in a case where the merchant wishes to guide the clustering process. Common product and positioning attributes of successful and unsuccessful products may be drawn from the clusters. These attributes represent successful and unsuccessful combinations that the merchant may wish to replicate or avoid, respectively, when the new product is introduced.

Online Market Research (OMR) experiments are optionally formulated and conducted to gauge preferences and/or perceptions of customers or repondents, at optional step 435.

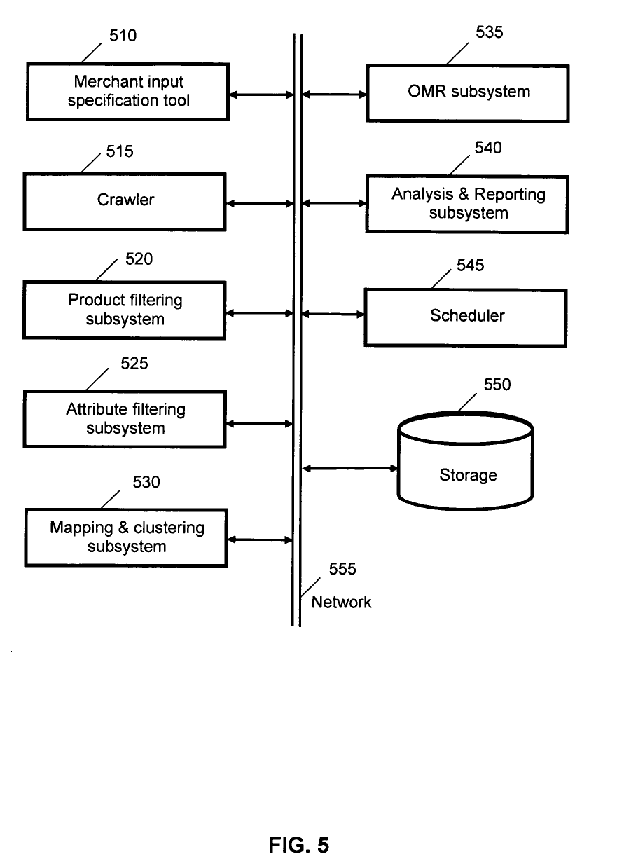

The foregoing steps 415 to 430 (and, optionally, step 435) are repeated periodically and changes relating to similar products are detected and monitored at step 440. Such changes may comprise the introduction of a competitor's new product, which may be detected by way of a change in the list of similar products since the last crawl. The effects of such changes on customer perceptions and sales of the merchant's products specified in step 410 are evaluated using data analysis techniques such as multivariate regression. Periodic repetition of steps 415 to 430 (and, optionally, step 435) can be performed using a scheduler, such as shown in FIG. 5, hereinafter.

At step 445, products requiring repositioning and/or repricing are identified based on the changes detected in step 440 violating predefined thresholds and/or thresholds explicitly specified by the merchant. The products identified at step 445 are reported to the merchant with one or more suggested alternatives for repricing and/or repositioning (i.e., changes in the marketing mix).

One or more alternative marketing mixes are selected at step 450 and tested by OMR experiments at step 455. The alternative mixes are typically selected by the merchant.

At step 460, the marketing mix is finalized. If the performance of the marketing mix in the OMR is unacceptable to the merchant, new marketing mixes may be suggested or merchant input may be taken and tested with subsequent OMR experiments. This cycle may continue until an acceptable marketing mix is obtained or the process may be aborted.

FIG. 5 shows a schematic block diagram of a system for positioning and/or pricing a new product and for identifying a need for reconfiguring, repositioning and/or repricing an existing product.

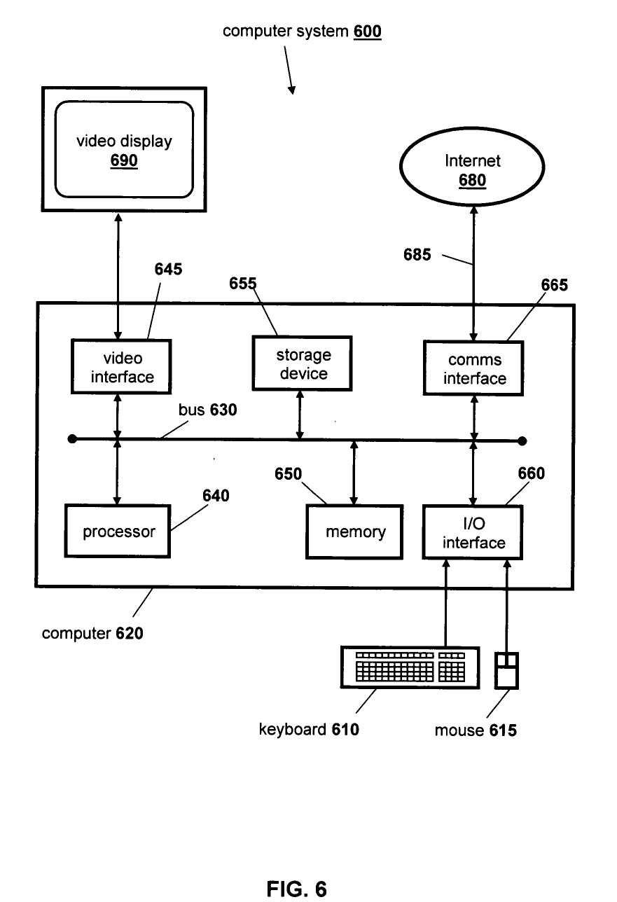

The system comprises a merchant input specification tool 510, a crawler 515, a product filtering subsystem 520, an attribute filtering subsystem 525, a mapping and clustering subsystem 530, an online market research (OMR) subsystem 535, an analysis and reporting subsystem 540, a scheduler 545 and data storage 550. FIG. 5 shows the foregoing components 510 to 550 practiced in a distributed manner with each component connected via a network 555. However, as would be understood by those skilled in the art, certain or all of the components 510 to 550 may be practiced in various combinations using a number of separate computer systems (e.g, 3 or 4 computer systems such as the computer system 600 shown in FIG. 6). Alternatively, all of the components 510 to 550 may be practiced using a single computer system such as the computer system 600 shown in FIG. 6. Certain of the components 510 to 550 may be inessential for practicing certain embodiments of the present invention. For example, the methods shown in FIG. 1 and FIG. 2 do not require the scheduler 545.

The merchant input specification tool 510 is used to specify the merchant's product. The crawler 515 examines or ‘crawls’ websites to locate products similar to a specified product and additionally gathers information about the positioning attributes and values relating to those products for processing by the product filtering subsystem 520 and the attribute filtering subsystem 525. The operation of the crawler 515 has some similarities to “shopbots”, which are automated software agents that automatically gather and collate information from multiple on-line vendors about the price and quality of consumer goods and services. Information gathered by shopbots is forwarded to customers for assistance in making a final purchasing decision.

The product filtering subsystem 520 filters the products found by the crawler 515. The attribute filtering subsystem 525 filters the list of product and positioning attributes obtained by the crawler 515. The filtered data is used by the mapping and clustering subsystem 530 to identify desirable attributes. The mapping and clustering subsystem 530 may also identify “holes” in the market space (i.e., regions of low product density on the product attribute map). Such “holes” may result from unattractive attribute combinations or potential opportunities overlooked by competitors.

The OMR subsystem 535 formulates one or more explicit and/or implicit OMR experiments to obtain customer or market preferences and/or perceptions of the shortlisted products offered by competitors. The analysis and reporting subsystem 540 uses the results of the online market research to identify at least one potential market position for the merchant's product.

FIG. 6 is a schematic representation of a computer system 600 that can be used to practice the methods described herein for aiding new product introduction and for identifying a need for reconfiguration, repositioning and/or repricing existing products. The computer system 600 is provided for executing computer software that is programmed to assist in performing the described methods. The computer software typically executes under an operating system such as MSWindows XP™ or Linux™installed on the computer system 600.

The computer software comprises a set of programmed logic instructions that may be interpreted by the computer system 600 for instructing the computer system 600 to perform predetermined functions specified by those instructions. The computer software may be an expression recorded in any language, code or notation, comprising a set of instructions intended to cause a compatible information processing system to perform particular functions, either directly or after conversion to another language, code or notation.

The computer software program comprises statements in an appropriate computer language. The computer program may be processed using a compiler into computer software that has a binary format suitable for execution by the operating system. The computer program is programmed in a manner that involves various software components, or code means, that perform particular steps in the methods described hereinbefore.

The components of the computer system 600 include: a computer 620, input devices 610, 615 and a video display 690. The computer 620 includes: a processing unit 640, a memory unit 650, an input/output (I/O) interface 660, a communications interface 665, a video interface 645, and a storage device 655. The computer 620 may comprise more than one of any of the foregoing units, interfaces, and devices.

The processing unit 640 may comprise one or more processors that execute the operating system and the computer software executing under the operating system. The memory unit 650 may comprise random access memory (RAM), read-only memory (ROM), flash memory, and/or any other type of memory known in the art for use under direction of the processing unit 640.

The video interface 645 is connected to the video display 690 and provides video signals for display on the video display 690. User input to operate the computer 620 is provided from input devices 610, 615, comprising a keyboard and a mouse, respectively. The storage device 655 may comprise a disk drive or any other suitable non-volatile storage medium.

Each of the components of the computer 620 is connected to a bus 630 that comprises data, address, and control buses, to allow the components to communicate with each other via the bus 630.

The computer system 600 may be connected to one or more other similar computers via the communications interface 665 using a communication channel 685 to a network 680, represented as the Internet.

The computer software program may be provided as a computer program product, and recorded on a portable storage medium. In this case, the computer software program is accessed by the computer system 600 from the storage device 655. Alternatively, the computer software can be accessed directly from the network 680 by the computer 620. In either case, a user can interact with the computer system 600 using the keyboard 610 and mouse 615 to operate the programmed computer software executing on the computer 620.

The computer system 600 has been described for illustrative purposes. Accordingly, the foregoing description relates to an example of a particular type of computer system suitable for practicing the methods and/or computer program products described hereinbefore. Other configurations or types of computer systems can equally well be used to practice the methods and/or computer program products described hereinbefore, as would readily be understood by persons skilled in the art.

Conclusion

Embodiments described hereinbefore for aiding new product introduction and for identifying a need for repositioning and/or repricing existing products advantageously reduce dependence on heuristics and the subjective judgment of a merchant.

The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

1. An automated method for aiding new product introduction, said method comprising the steps of:
obtaining data relating to a proposed new product from a merchant;
obtaining, from competitors' websites, data relating to products similar to said proposed new product;
processing said data relating to said similar products;
identifying product attributes and positioning attributes based on said the processed data;
conducting online market research based on the identified attributes; and
identifying at least one marketing mix for said proposed new product based on a result of said online market research.

2. The method of claim 1, wherein said at least one marketing mix comprises one or more product characteristics selected from the group of product characteristics consisting of:
product configuration;
product pricing; and
product positioning.

3. The method of claim 1, comprising the further steps of:
obtaining input from said merchant in response to said at least one marketing mix; and
conducting further online market research based on said input.

4. The method of claim 1, wherein said data relating to said similar products comprises one or more data items for each of said similar products, said data items selected from the group of data items consisting of:
a product attribute name-value pair;
a positioning attribute name-value pair; and
product pricing.

5. The method of claim 4, wherein said step of processing comprises the sub-steps of:
filtering a list of said similar products;
filtering said product and positioning attributes.

6. The method of claim 5, wherein said step of identifying product attributes and positioning attributes comprises a plurality of sub-steps selected from the group of sub-steps consisting of:
generating a product attribute map by mapping said similar products onto said product attributes;
generating a positioning attribute map by mapping said similar products onto said positioning attributes;
identifying areas on said product attribute map that are uninhabited by said similar products;
identifying areas on said positioning attribute map that are uninhabited by said similar products;
applying clustering techniques to said product attribute map to identify clusters of products having similar product attributes; and
applying clustering techniques to said positioning attribute map to identify clusters of products having similar positioning attributes.

7. An automated method for identifying a need for reconfiguring, repositioning and/or repricing a product, said method comprising the steps of:
obtaining data relating to one or more of a merchant's products;
periodically obtaining data, from competitors' websites, relating to products similar to said merchant's product;
processing said data relating to the similar products;
identifying product attributes and positioning attributes based on said the processed data;
detecting a change in the identified product and positioning attributes relating to at least one similar product; and
identifying one or more of said merchant's products that require repositioning and/or repricing based on the detected change.

8. The method of claim 7, comprising the further steps of:
conducting online market research based on said identified attributes; and identifying at least one marketing mix for one or more of said merchant's products based on a result of said online market research.

9. The method of claim 7, wherein said at least one marketing mix comprises one or more product characteristics selected from the group of product characteristics consisting of:
product configuration;
product pricing; and
product positioning.

10. The method of claim 7, comprising the further steps of:
obtaining input from said merchant in response to said at least one marketing mix; and
conducting further online market research based on said input.

11. The method of claim 7, wherein said data relating to said similar products comprises one or more data items for each of said similar products, said data items selected from the group of data items consisting of:
a product attribute name-value pair;
a positioning attribute name-value pair; and
product pricing.

12. The method of claim 11, wherein said step of processing comprises the sub-steps of:
filtering a list of said similar products;
filtering said product and positioning attributes.

13. The method of claim 12, wherein said step of identifying product attributes and positioning attributes comprises a plurality of sub-steps selected from the group of sub-steps consisting of:
generating a product attribute map by mapping said similar products onto said product attributes;
generating a positioning attribute map by mapping said similar products onto said positioning attributes;
identifying areas on said product attribute map that are uninhabited by said similar products;
identifying areas on said positioning attribute map that are uninhabited by said similar products;
applying clustering techniques to said product attribute map to identify clusters of products having similar product attributes; and
applying clustering techniques to said positioning attribute map to identify clusters of products having similar positioning attributes.

14. A computer program product comprising a computer readable medium comprising a computer program recorded therein for aiding new product introduction, said computer program product comprising:
computer program code means for obtaining data relating to said merchant's product;
computer program code means for obtaining, from competitors' websites, data relating to products similar to said merchant's product;
computer program code means for processing said data relating to the similar products;
computer program code means for identifying product attributes and positioning attributes based on the processed data;
computer program code means for conducting online market research based on the identified attributes; and
computer program code means for identifying at least one marketing mix for said proposed new product based on a result of said online market research.

15. The computer program product of claim 14, wherein said at least one marketing mix comprises one or more product characteristics selected from the group of product characteristics consisting of:
product configuration;
product pricing; and
product positioning.

16. The computer program product of claim 14, further comprising:
computer program code means for obtaining input from said merchant in response to said at least one marketing mix; and
computer program code means for conducting further online market research based on said input.

17. The computer program product of claim 14, wherein said data relating to said similar products comprises one or more data items for each of said similar products, said data items selected from the group of data items consisting of:
a product attribute name-value pair;
a positioning attribute name-value pair; and
product pricing.

18. The computer program product of claim 17, wherein said computer program code means for processing comprises:
computer program code means for filtering a list of said similar products;
computer program code means for filtering said product and positioning attributes.

19. The computer program product of claim 18, wherein said computer program code means for identifying product attributes and positioning attributes comprises a plurality of computer program code means selected from the group consisting of:
computer program code means for generating a product attribute map by mapping said similar products onto said product attributes;
computer program code means for generating a positioning attribute map by mapping said similar products onto said positioning attributes;
computer program code means for identifying areas on said product attribute map that are uninhabited by said similar products;
computer program code means for identifying areas on said positioning attribute map that are uninhabited by said similar products;
computer program code means for applying clustering techniques to said product attribute map to identify clusters of products having similar product attributes; and
computer program code means for applying clustering techniques to said positioning attribute map to identify clusters of products having similar positioning attributes.

20. A computer program product comprising a computer readable medium comprising a computer program recorded therein for identifying a need for reconfiguring, repositioning and/or repricing a product, said computer program product comprising:
computer program code means for obtaining data relating to one or more of a merchant's products;
computer program code means for periodically obtaining data, from competitors' websites, relating to products similar to said merchant's product;
computer program code means for processing said data relating to the similar products;
computer program code means for identifying product attributes and positioning attributes based on the processed data;
computer program code means for detecting a change in the identified product and positioning attributes relating to a similar product; and
computer program code means for identifying one or more of said merchant's products that require repositioning and/or repricing based on the detected change.

21. The computer program product of claim 20, further comprising:
computer program code means for conducting online market research based on said identified attributes; and
computer program code means for identifying at least one marketing mix for one or more of said merchant's products based on a result of said online market research.

22. The computer program product of claim 20, wherein said at least one marketing mix comprises one or more product characteristics selected from the group of product characteristics consisting of:
product configuration;
product pricing; and
product positioning.

23. The computer program product of claim 20, further comprising:
computer program code means for obtaining input from said merchant in response to said at least one marketing mix; and
computer program code means for conducting further online market research based on said input.

24. The computer program product of claim 20, wherein said data relating to said similar products comprises one or more data items for each of said similar products, said data items selected from the group of data items consisting of:
a product attribute name-value pair;
a positioning attribute name-value pair; and
product pricing.

25. The computer program product of claim 24, wherein said computer program code means for processing comprises:
computer program code means for filtering a list of said similar products;
computer program code means for filtering said product and positioning attributes.

26. The computer program product of claim 25, wherein said computer program code means for identifying product attributes and positioning attributes comprises a plurality of computer program code means selected from the group consisting of:
computer program code means for generating a product attribute map by mapping said similar products onto said product attributes;
computer program code means for generating a positioning attribute map by mapping said similar products onto said positioning attributes;
computer program code means for identifying areas on said product attribute map that are uninhabited by said similar products;
computer program code means for identifying areas on said positioning attribute map that are uninhabited by said similar products;
computer program code means for applying clustering techniques to said product attribute map to identify clusters of products having similar product attributes; and
computer program code means for applying clustering techniques to said positioning attribute map to identify clusters of products having similar positioning attributes.

27. A system for aiding new product introduction, comprising:
a merchant input specification tool for obtaining data relating to a proposed new product;
a crawler for obtaining data relating to products similar to said proposed new product from competitors' websites, said data comprising product and positioning attributes;
a product filtering subsystem for filtering data of the similar products;
an attribute filtering subsystem for filtering said attributes of said similar products;
a mapping and clustering subsystem for identifying product and positioning attributes common to selected ones of said similar products based on the filtered data;
an online market research subsystem for identifying preferences based on said product and positioning attributes; and
an analysis and reporting subsystem for identifying at least one marketing mix for said proposed new product based on a result of said online market research.

28. The system of claim 27, wherein said at least one marketing mix comprises one or more product characteristics selected from the group of product characteristics consisting of:
product configuration;
product pricing; and
product positioning.

29. The system of claim 27, wherein said data relating to said similar products comprises one or more data items for each of said similar products, said data items selected from the group of data items consisting of:
a product attribute name-value pair;
a positioning attribute name-value pair; and
product pricing.

30. The system of claim 29, wherein said mapping and clustering subsystem:
generates a product attribute map by mapping said similar products onto said product attributes;
generates a positioning attribute map by mapping said similar products onto said positioning attributes;
identifies areas on said product attribute map that are uninhabited by said similar products;
identifies areas on said positioning attribute map that are uninhabited by said similar products;
applies clustering techniques to said product attribute map to identify clusters of products with similar product attributes; and
applies clustering techniques to said positioning attribute map to identify clusters of products having similar positioning attributes.

31. A system for identifying a need for reconfiguring, repositioning and/or repricing a product, comprising:
an input specification tool for obtaining data relating to a merchant's products;
a crawler for obtaining data relating to products similar to said merchant's products from competitors' websites, said data comprising product and positioning attributes;
a product filtering subsystem for filtering data of the similar products;
an attribute filtering subsystem for filtering said attributes of said similar products;
a mapping and clustering subsystem for identifying product and positioning attributes common to selected ones of said similar products based on the filtered data;
an online market research subsystem for identifying preferences based on said product and positioning attributes;
an analysis and reporting subsystem for identifying at least one marketing mix for one or more of said merchant's products based on a result of said online market research; and
a scheduler for causing periodic operation of said crawler and the subsystems.

32. The system of claim 31, wherein said at least one marketing mix comprises one or more product characteristics selected from the group of product characteristics consisting of:
product configuration;
product pricing; and
product positioning.

33. The system of claim 31, wherein said data relating to said similar products comprises one or more data items for each of said similar products, said data items selected from the group of data items consisting of:
a product attribute name-value pair;
a positioning attribute name-value pair; and
product pricing.

34. The system of claim 33, wherein said mapping and clustering subsystem:
generates a product attribute map by mapping said similar products onto said product attributes;
generates a positioning attribute map by mapping said similar products onto said positioning attributes;
identifies areas on said product attribute map that are uninhabited by said similar products;
identifies areas on said positioning attribute map that are uninhabited by said similar products;
applies clustering techniques to said product attribute map to identify clusters of products with similar product attributes; and
applies clustering techniques to said positioning attribute map to identify clusters of products having similar positioning attributes.

35. An automated method for aiding new product introduction, said method comprising the steps of:
obtaining data relating to a proposed new product from a merchant;
obtaining, from competitors' websites, data relating to products similar to said proposed new product;
processing said data relating to the similar products;
identifying product attributes and positioning attributes based on said processed data; and
identifying at least one marketing mix for said proposed new product based on selected ones of the identified attributes.
